(19) United States
(12) Patent Application Publication
(10) Pub. No.: US 2020/0268014 A1
(43) Pub. Date: Aug. 27, 2020

(54) PROTEIN INGREDIENT MADE FROM OILSEEDS OF SUNFLOWERS OR RAPE, AND THE PRODUCTION THEREOF

(71) Applicant: FRAUNHOFER-GESELLSCHAFT ZUR FOERDERUNG DER ANGEWANDTEN FORSCHUNG E.V., Muenchen (DE)

(72) Inventors: PETER EISNER, Freising (DE); STEPHANIE MITTERMAIER, Moosburg a. d. lsar (DE); RAFFAEL OSEN, Freising (DE); GABRIELE DOER, Markt-Schwaben (DE); ANNA MARTIN, Miltach (DE)

(21) Appl. No.: 16/643,671

(22) PCT Filed: Sep. 11, 2018
(86) PCT No.: PCT/EP2018/074408

§ 371 Date: Mar. 2, 2020

(30) Foreign Application Priority Data
Sep. 11, 2017 (DE) 10 2017 120 906.9

(51) Int. Cl. A23J 1/14; A23K 10/30; A23K 20/147; A23K 50/40

(52) U.S. Cl. CPC A23J 1/144; A23K 50/40; A23K 20/147; A23K 10/30

(57) ABSTRACT

A method for obtaining a protein ingredient for animal feed from seeds of sunflowers or rape includes shelling the sunflower seeds or rapeseeds up to a shell content of <2.5 wt %, mechanically partially extracting the oil from the shelled sunflower seeds or rapeseeds by pressing, up to a fat or oil content in the region of >6 and <25 wt %, and carrying out at least one extraction step for further extraction of the oil with at least one organic solvent or supercritical CO2, up to an oil content of less than 3.5 wt %; and subsequently desolventing, wherein at least one protein-denaturing treatment of the sunflower seeds or rapeseeds is carried out between the shelling of the sunflower seeds or rapeseeds and the obtaining of the protein ingredient. Due to its good digestibility, the protein ingredient can be used as an at least partial replacement for animal proteins in animal feeds.

### APPLICATION AREA

The invention relates to a method for obtaining protein ingredients from seeds of sunflowers or rape for use in animal feed, technical additives or foods, and protein ingredients produced with the method and feedstuffs which contain these ingredients.

### RELATED ART

Against the background of a growing global population and dwindling space and resources, plant-based protein preparations are becoming increasingly important as sources of nourishment for humans, for technical applications and for use as animal feed. The rising demand for animal foodstuffs which goes hand-in-hand with the global increase in wealth leads to a growing need for protein preparations which are optimised for nutritional purposes, which can be almost entirely metabolised particularly by animals, and which can be produced easily and inexpensively. In this respect, existing animal feed ingredients still have deficiencies, some of which are considerable.

Animal feeds with plant-based ingredients are extremely important for the production of animal food products. They serve as a method of supplying the animals with proteins, carbohydrates, lipids and Micronutrients. Particularly important for the growth of the animals are the biological quality and the bioavailability of the proteins and amino acids contained in the animal feeds. The protein fraction in animal feeds is significant from a financial point of view as well, because this fraction is responsible for a considerable portion of the costs.

Most of the plant-based protein preparations for animal feeds on the market consist of soya beans, soya extraction grist, soya protein preparations or cereal flours and cereal protein preparations. Otherwise, proteins from other legumes such as peas, broad beans and lupins are used, and protein-rich residues from food processing operations such as spent grains are also used as feed.

One inexpensive source of proteins are the residues from pressing and extraction operations carried out for obtaining cooking oil from the seeds of sunflowers and rape. These seeds are characterized by a predominantly dark coloured solid shell and an oil-containing fruit flesh.

It is possible to shell these seeds, but the operation is very complicated particularly in the case of rapeseeds. For the purpose of the present patent application, the term shell is used to refer generally to all constituents of the seeds which do not include cotyledons or the embryo, e.g., further hulls in the seeds besides the cellulose-rich testa, such as the cuticle.

Sunflower seeds contain up to 50 wt % oil and on average about 18 wt % protein. Rapeseeds contain up to 45 wt % oil and as much as 25 wt % protein. By pressing the seeds and extracting the press cake using organic solvents, the oil content in the extraction residue can be reduced to less than 3.5 wt % (Soxhlet method) and the protein content can be increased to more than 40 wt % depending on the raw material. Consequently, these residues are eminently suitable for use as protein-rich ingredients in animal feeds.

The pressing and extraction residues which are created during oil recovery are already used in industry today. However, their use is very limited despite their high protein content. One of the reasons given for this in the literature is that the digestibility and availability of the protein is reduced by the high process temperatures employed in the oil recovery and the associated loss of essential amino acids such as lysine, methionine or cysteine (Björck, I. & Asp, N. G. (1983). The effects of extrusion cooking on nutritional value—a literature review. Journal of Food Engineering, 2, 281-308). In some cases, the digestibility of the proteins from hot-treated press and extraction residues may be reduced to less than 40% (Geoff L. Allan, Scott Parkinson, Mark A. Booth, David A. J. Stone, Stuart J. Rowland, Jane Frances, Rebecca Warner-Smith. Replacement of fish meal in diets for Australian silver perch, Bidyanus bidyanus: I. Digestibility of alternative ingredients. Aquaculture 186 _2000. 293-310.; Brett Glencross, Wayne Hawkins & John Curnow. Nutritional assessment of Australian canola meals. I. Evaluation of canola oil extraction method and meal processing conditions on the digestible value of canola meals fed to the red seabream (Pagrus auratus, Paulin). Aquaculture Research, 2004, 35, 15-24). This means that substantially less than half of the proteins used in animal feed can be metabolised by the animals.

It is also reported that the proportion of undesirable accompanying substances, particularly the proportion of secondary plant substances such as polyphenols, tannins, glucosinolates or phytic acid in these residues can be as high as 10 wt %, and that these compounds adversely affect the digestibility of the feed as well. Moreover, some secondary plant substances not only reduce the uptake of macro- and micronutrients from the animal feed, but also have a bitter taste and astringent effect. The sensory impression consequently produced in livestock by the animal feed means that the feed is often refused, particularly by pigs and cattle. Furthermore, the taste of derived products such as eggs can also be adversely affected by secondary plant substances from rape or sunflowers. For example, sinapine, which is contained in rapeseeds, can cause a fishy aroma in eggs from laying hens with rape extraction residues are used animal feeds.

According to the related art, sunflower seeds and rapeseeds are processed mainly with a view to obtaining a high oil yield. To this end, they are first freed from dockage, partially conditioned (setting of a defined temperature and moisture level), then a preliminary oil extraction is carried out mechanically by pressing (residual oil contents not more than 10 wt %) after which the remaining oil content is extracted from the press cakes with hexane. “Finish pressing” may also be carried out to obtain residual oil contents of about 5 wt % without subsequent extraction, although the residual oil content in the press cakes reduces the storage stability of the residues.

According to the related art, sunflower seeds and rapeseeds are most often pressed without having the shell removed or only partially removed. In the case of partial shelling, more than 45 wt % of the shells contained in the seeds remain in the raw material before the is removed, which corresponds on average to a remaining shell content before pressing of >10 wt % in sunflower seeds and >8 wt % in rapeseeds. It is considered necessary in the related art particularly for pressing, i.e. finish pressing or preliminary pressing as a partial oil removal step, to have a shell content of at least 10 wt % in order to make it easier to drain the oil from the press and so increase the pressing speed.

A high processing speed is very important particularly for animal feed, because animal feed cannot command high prices, so a pressing operation that took too long would make it impossible to realise a profit by reusing the press cakes as animal feed.

The press cakes and grist recovered from unshelled or partially shelled seeds are usually dark in colour after a rapid, hot processing step, and have a very high crude fibre content of up to 44 wt % and a bitter-astringent taste. They are therefore not suitable for producing high-value protein flours for applications outside of the low-cost animal feed sector and are poorly digestible, which can be attributed to the heat damage suffered by the proteins. Due to the presence of secondary plant substances they are suitable for feeding to only a few animal types.

For several years, attempts have also been made to prepare protein flours or concentrates from the residues from sunflower oil or rapeseed oil recovery, and so make them usable for food and high-value applications. These efforts are directed chiefly at removing nuisance polyphenols, mainly chlorogenic acid, sinapine or sinapinic acid, which impair the taste of isolates of sunflower and rape proteins, and removing glucosinolates.

In the past, extractions using various solvents, also including water with different pH-values and mixtures of alcohols and water to remove the polyphenols from de-oiled sunflower and rape grist were suggested for this. In this context, particularly butanol in various proportions with hydrochloric water, ethanol with a content of 95% (v/v), isopropanol (70% v/v) and methanol (80% v/v) were used to remove the phenolic substances from sunflower seeds with the fat removed. A disadvantage when extracting with these solvents is that the proteins are largely denatured by the solvent treatment, with the result that the solubility of the proteins is reduced substantially. Moreover, the protein availability is reduced considerably by the chemical reaction of amino acids.

Other publications describe the production of protein concentrates from rapeseeds and sunflower seeds. These protein concentrates are recovered by dry or wet technical processing, wherein the protein remains in the residue. However, the high proportion of undesirable accompanying substances (secondary plant substances) and the high crude fibre content limit their use as animal feed, so there does not appear to be a significant advantage over the sunflower and rape extract grist. Therefore, most protein concentrates have a limited application range and can only be used in low concentrations in animal feeds.

A method for obtaining sunflower protein as a protein rich animal feed is described in EP 2 885 980 B1. In order to produce the animal feed, shelled sunflower seeds with a residual shell content of >5 wt % are used. The seeds are pressed until they have an oil content from ≥8 wt % to ≤18 wt % and a protein content from ≥30% to ≤45% relative to dry weight. The effect of the residual shell content of ≤5 wt % on the digestibility of the proteins is not discussed. In this context too, it is assumed that the high crude fibre content and the high chlorogenic acid content of the product will severely limit its acceptance and thus also its usability as animal feed.

EP 2 400 859 A2 also describes a method for production of protein preparations from shelled sunflower seeds with a residual shell content ≤5 wt %. This relates to the production of protein preparations for use in foodstuffs. The low residual shell content means that it is possible to achieve a high protein content of more than 45 wt % in the product with the oil removed. Due to the low temperatures that prevail because pressing is carried out at below 80° C. and desolventing at below 90° C., with this method good technofunctional properties are retained, a low degree of denaturing occurs, and consequently it may be expected that very good digestibility and bioavailability are achieved. However, the low temperatures that prevail while the sunflower seeds are being processed result in very long residence times in the individual process stages, which in turn entail very highs costs for the overall process. This severely limits the usability of the preparations in the field of animal feed, and also in the field of producing inexpensive foodstuffs.

The problem addressed by the present invention is that of providing a method for the production of qualitatively high-value protein ingredients from sunflower seeds or rapeseeds, of which the proteins are readily digestible and agreeable to the senses due to the low contents of secondary plant substances and fibres, and which are also nutritionally valuable and consequently highly versatile ingredients in animal feeds due to their high protein content and the fact that the properties of the proteins are largely retained.

### DESCRIPTION OF THE INVENTION

This problem is solved with the method according to Claim 1. The further claims describe preferred variants of the method, a protein ingredient that may be produced with the method, and the preferred use thereof in animal feeds.

In the present method for obtaining high-value protein ingredients from sunflower seeds and rapeseeds, first the seeds are shelled, and the shells are separated from the kernel, preferably by sieving, sifting and sorting, so that a shell content of <2.5 wt %, advantageously <1 wt %, particularly advantageously <0.25 wt % is obtained.

In order to change the protein solubility with the objective of obtaining denaturing effects in the protein, at least one protein-denaturing treatment must be carried out during the steps for processing the shelled seeds as far as the protein preparation with the oil removed (pressing, extracting, desolventing optionally grinding), in order to achieve a denaturing of the proteins contained in the protein ingredient to a proportion of >40%. This is understood to be either a temperature-time load which is characterized in that the sunflower or rape proteins are placed under load in the course of the processing for at least 10 minutes, advantageously for more than 30 minutes with a temperature of more than 90° C., advantageously over 100° C., advantageously over 110° C., particularly advantageously over 120° C. and under 150° C. Another protein-denaturing treatment according to the invention may be carried out also in addition to the temperature-time load in the form of an aqueous-alcoholic treatment of the protein in a mass ratio of alcohol to water between 1:20 and 20:1 and at a temperature higher than 40° C., preferably higher than 50° C. Monovalent alcohols such as methanol, ethanol, propanol, isopropanol or butanol may advantageously be used as alcohols.

With this protein-denaturing treatment following extensive shelling, it is ensured that for the application in animal feed only a very small content of shell and fibre is contained in the extracted press cake, other undesirable accompanying substances have been reduced, and at the same time the proteins are bound firmly in the remaining carbohydrate matrix of the kernel as a result of the (partial) denaturing, which considerably reduces protein losses along the value-added chain of the protein preparation until the feeding. This helps to ensure for example that when fed to fish in water the proteins are dissolved out of the protein preparation only very slowly, and consequently only small losses take place into the environment via aqueous phases.

For the further processing after the shelling, preferably after conditioning by setting temperature and moisture the shelled seeds are pressed to an oil content of <25 wt %, advantageously <15 wt % particularly advantageously <10 wt %, but >6 wt %, advantageously >9 wt % by pressing, and the press cake obtained by this mechanical partial oil removal then undergoes oil extraction by means of extracting agents (e.g., hexane, ethanol, supercritical CO₂, ethyl acetate or mixtures thereof) up to an oil content (determined according to the Soxhlet method) of less than 3.5 wt %, advantageously less than 2 wt %.

In a preferred variant, the temperature should exceed a value of 75° C. at least in parts of the product during the pressing, advantageously a temperature of over 85° C., particularly advantageously over 95° C. is reached in the press cake during pressing. This may be assured for example by heating the press, by preheating the kernels or with high shearing forces and pressures in the press. This results in a significant increase in the speed at which the oil is removed, a denaturing of the proteins, and a solidification of the press residue. The consequence of the solidification of the press residues which takes place at elevated temperatures is that less abrasion takes place during the transportation of the residues between the individual oil removal process stages or in the subsequent oil extraction, accordingly fewer losses occur and also fewer problems arise during the processing of the miscella (oil-solvent mixture) as fewer fine abrasion particles are separated from the protein preparation via the miscella. Thus, the losses from abrasion are reduced and the process is rendered more efficient by the pressing according to the invention. In the process, for example a mechanical strength and/or fracture pressure greater than 10 N/mm², measured with a Texture Analyzer (TA) under radial compressive load, is achieved in the pressure cakes for a round press cake strand with a diameter of 8 mm by correspondingly high temperatures.

After the extraction of the pre-pressed oil seeds with solvents, which should be carried out directly with the press cake or following an advanced mechanical treatment of the press cake (e.g., grinding and pelletising), the separation preferably by distillation of the solvent by desolventing is carried out preferably with the application of heat in the form of superheated organic solvents and/or by the use of water vapour. For the desolventing in one advantageous variant of the method according to the invention a temperature of >90° C. should be chosen. Advantageously, a temperature above 100° C., particularly advantageously above 120° C. and below 150° C. should be set in the heat transfer media. In this process, a further denaturing of the proteins takes place, which is above 40%, advantageously above 70%, particularly advantageously above 90%. The denaturing of the protein is determined by DSC, as described in EP 2 400 859 A2 for example. With this method, when the denaturing is determined the DSC peak area (enthalpy) is determined in comparison with the peak area in untreated seeds, standardised to the protein content. The denaturing corresponds to area loss, i.e., no more area appears for 100% denaturing.

The high degree of denaturing and the reduced solubility of the sunflower protein or rapeseed protein resulting therefrom prompt the expectation of reduced bioavailability and poorer quality properties compared with native proteins, as is known from extraction residues according to the related art (S. Gonzalez-Perez, 2007: Sunflower proteins: overview of their physicochemical, structural and functional properties. Journal of the Science of Food and Agriculture 87(12); A. Moure et al., 2006: Functionality of oilseed protein products: A review, Food Research International, Volume 39, Issue 9). However, when a denatured protein ingredient after the treatment according to the invention is used, surprisingly it was found in testing with animals, for example when used to feed trout that despite a decrease of the protein solubility to less than 40% at pH 7 and a denaturing of more than 60% the protein digestibility reaches more than 80% in some cases, very much higher than that of extraction residues according to the related art. Extraction residues according to the related art also have low solubility and high denaturing, but consistently have a shell content greater than 10 wt %.

In order to determine the digestibility in this case, fish are fed with experimental rations, and the excrement is recovered by skimming. The digestibilities are calculated in accordance with the NRC recommendations (National Research Council. 2011. Nutrient Requirements of Fish and Shrimp. Washington, D.C.: The National Academies Press. https://doi.org/10.17226/13039).

Thus, the reduction of the shell content in the extraction residues seems to affect the digestibility of the proteins in the feeding tests disproportionately. At the same time, a target of less than 5 wt % should be set for the shell content in the residue after the oil has been removed, and a reduction to less than 2 wt %, advantageously less than 0.5 wt % shells brings further significant advantages in terms of digestibility. This low shell content is achieved in the suggested method by the provision of shelled sunflower seeds or rapeseeds with a shell content of <2.5 wt %, advantageously <1 wt %, particularly preferably <0.25 wt % for the mechanical partial oil removal, since the extraction residues from rapeseeds or sunflower seeds after the oil has been removed correspond to only about 50% of the mass of the rapeseeds and sunflower seeds.

Thus, the use of the protein preparations from rapeseeds or sunflower seeds according to the invention presents itself favourably as a high-value alternative for animal proteins such as fish meal, animal meal, blood meal or feather meal. Replacement rates from 35% up to advantageously 60%, still more advantageously up to 80%, particularly advantageously up to 100% of animal meals with the protein ingredient according to the invention appear reasonable and possible. Such a substitution up to a largely complete replacement of animal components in animal feed is of great advantage not only for reasons of sustainability but also profitability.

A very good digestibility of the protein is assured by the method according to the invention despite the extensive protein denaturing due to the high temperatures. This is also demonstrated when the method described is followed by treatment with alcohol-water mixtures with the purpose of separating secondary plant substances (e.g., polyphenols) of which have an active taste component and are to a certain extent anti-nutritional. Despite an even more extensive denaturing of the proteins to more than 80% by this process step, the digestibility remains almost unchanged. In experiments it was found that when these protein ingredients from rape or sunflower are used as animal feed, a weight gain by the animals follows which is comparable to conventional animal feeds with the same protein content. It therefore seems particularly advisable to add an alcohol-water extraction step after the oil removal in order to obtain good animal feed properties.

Particular benefits are also gained if the denaturing step is performed not immediately at the start of the treatment, that is to say during the pressing, but if a less intense pressing with a medium temperature of the kernel fraction is initially carried out for the duration of the pressing operation below 80° C., advantageously below 70° C., and the oil extraction also takes place below 80° C., and then a thermal denaturing is performed with a high temperature during desolventing at >100° C., advantageously >120° C. It may also be beneficial to dispense with thermal step >100° C. after the oil is removed, and not to introduce an elevated temperature >100° C. until after a treatment of the protein with an alcohol-water mixture has been completed. In this way, the protein can be denatured more effectively still.

### Properties of Rape Protein

According to the method, a protein ingredient made from rapeseeds and produced with the method has the following properties (the analytical methods are described in EP 2 400 859 A2 and elsewhere):
Hexane content between 0.0001 and 2 wt % and/or
Alcohol content between 0.0001 and 2 wt %
Protein content >45 wt % and less than 80 wt % (determined with Dumas N*6.25)
Fat content <3.5 wt % (determined with hexane in the Soxhlet method)
Protein solubility <40%, advantageously <25%, particularly advantageously <20% (method according to Morr et al. 1985 and determination of the NSI)
Shell content less than 5 wt %, advantageously <2 wt %, particularly advantageously <0.5 wt %,
Denaturing the protein: >40%, advantageously >70%, particularly advantageously >80%, (determined by DSC)
Digestibility of the protein: >60%, advantageously >80%

### Properties of Sunflower Protein

A protein ingredient made from sunflower seeds and produced with the method has the following properties according to the invention (determined by the same determination method as for the rape protein):
Hexane content between 0.0001 and 2 wt % and/or
Alcohol content between 0.0001 and 2 wt %
Protein content >45 wt % and <80 wt % (determined with Dumas N*6.25)
Fat content <3.5 wt % (determined with Soxhlet method)
Protein solubility <30%, advantageously <25% or <20%
Shell content less than 5 wt %, advantageously <2 wt %, particularly advantageously <0.5 wt %,
Denaturing of the protein: >40%, advantageously >70%, particularly advantageously >80%,
Digestibility of the proteins: >70%, advantageously >85%

Because of its good digestibility in animal feeds, a protein preparation according to the invention made from sunflowers can be used instead of the animal protein source (e.g., fish meal, blood meal, feather meal, etc.) in considerably higher concentrations than is possible with residues from sunflower oil recovery according to the related art, even though traces of organic solvents can still be detected in the animal feed.

In feeding experiments, the proportion of the preparation form sunflower seeds can replace up to 50% of the animal components in conventional feed with having to accept significant sacrifices in terms of animal growth. In the case of rapeseeds as well, a relatively high rate of substitution of animal components is possible, in this case the limit is at 45% in the animal feed after simple removal of the oil from the rape component using hexane. After further treatment with alcohol-water mixtures, the replacement of animal components with oil seed ingredients can be raised to 60% and still delivers financially reasonable growth rates.

Thus it is possible to prepare an animal feed with high rates of substitution of animal components with the protein preparations according to the invention. Animal feeds according to the invention from rapeseeds enable substitution rates higher than 30% with the protein ingredients from rape according to the invention, particularly advantageously higher than 40%, particularly advantageously higher than 45%. Animal feeds according to the invention from sunflower seeds enable substitution rates higher than 30% with the protein ingredients from sunflowers, particularly advantageously higher than 40%, particularly advantageously higher than 50%.

In a particularly advantageous variant of an animal feed according to the invention for carnivorous animals (e.g., salmon, trout), animal components are replaced entirely by a preparation from sunflower seeds according to the invention having a shell content <3.5 wt %. In this context, animal growth losses of up to 20% and lower digestibility compared to animal protein ingredients were found. Surprisingly however, it has been found that the animals fed with these animal feeds enjoy very high consumer acceptance despite reduced body weight and lower muscle protein. It is therefore advantageous to dispense with the addition of animal components despite the lower quality and to compensate for the possible deficits by the use of special amino acid or vitamin and mineral mixtures.

For use in animal feeds, it is helpful to mix the protein ingredients according to the invention with additional ingredients such as vitamins, minerals, amino acids/and/or proteins, sensory additives (colouring and flavouring substances), zootechnical additives (enzymes, prebiotics, . . . ), technological additives (e.g., binders, acidity regulators, . . . ) and oils.

In an advantageous variant of the use of the protein ingredient according to the invention as animal feed, the ingredient from sunflowers is mixed with soya protein for use as animal feed. The ratio of protein to mixture is then advantageously between 1:10 and 10:1, particularly advantageously between 30:70 and 70:30, very advantageously at 50:50 relative to the protein content. Surprisingly, it has been found that when both sunflower and soya are used good growth can be achieved, which delivers particularly high results due to the described properties of the sunflower preparation.

### EXEMPLARY EMBODIMENT

In order to produce an ingredient from sunflower kernels, the kernels were shelled to a residual shell content of <1 wt % and after setting a moisture of 5 wt % in the shelled sunflower kernels the oil was removed from them in a screw press at 95° C. to a residual fat content of 10 wt %.

This was followed by two different steps for mechanical post-treatment of the press cake to improve the oil extraction, once by flocking and once by pelletising after grinding.

A subsequent oil extraction process with hexane was carried out to a residual fat content of 2 wt % and desolventing of the hexane for 20 minutes with water vapour which was set to a temperature of 120° C. Following this, an extraction step with EtOH water in a mixture ratio of 50-50 by weight was carried out for 1 hour. The repeated desolventing of the EtOH water mixture was again carried out with water vapour at a temperature of 120° C. Then, the samples were ground finely for analysis. The ingredients obtained thereby had a protein solubility of 25% and a denaturing of 85%.

They were subsequently mixed with soya protein in a ratio of 20 wt % sunflower protein to 80 wt % soya protein and this mixture was added to salmon animal feed.

1. A method for obtaining protein ingredients for animal feed from seeds of sunflowers or rape, with at least the following steps
shelling the sunflower seeds or rapeseeds up to a shell content of <2.5 wt % to obtain shelled sunflower seeds or rapeseeds, or providing shelled sunflower seeds or rapeseeds having a shell content of <2.5 wt %;
mechanical partial extraction of the oil from the shelled sunflower seeds or rapeseeds by pressing up to a fat or oil content in the range between >6 and <25 wt %;
carrying out at least one extraction step for further extraction of the oil from the sunflower seeds or rapeseeds with at least one organic solvent or supercritical CO2 up to an oil content of less than 3.5 wt %, and
subsequent desolventing, whereby a protein-containing product is obtained as a protein ingredient for animal feed,
wherein at least one protein-denaturing treatment of the sunflower seeds or rapeseeds is carried out between the shelling of the sunflower seeds or rapeseeds and obtaining the protein ingredient in such manner that proteins contained in the protein ingredient are denatured to a percentage of >40%.

2. The method according to claim 1,
characterized in that
the protein-denaturing treatment is carried out by means of a temperature-time load in which proteins of the sunflower seeds or rapeseeds are exposed to a temperature higher than 90° C., preferably >100° C., and below 150° C. for at least 10 minutes (advantageously for over 30 minutes).

3. The method according to claim 1,
characterized in that
the mechanical partial extraction of oil from the shelled sunflower seeds or rapeseeds is carried out by pressing at an average temperature of the shelled sunflower seeds or rapeseeds of less than 80° C. over the duration of the pressing operation, and the at least one extraction step is also carried out at a temperature below 80° C.,
and that the protein-denaturing treatment is effected by a high temperature of >100° C. during the desolventing.

4. The method according to claim 1,
characterized in that
the protein-denaturing treatment is carried out by means of an aqueous-alcoholic treatment of proteins of the sunflower seeds or rapeseeds at a mass ratio of alcohol and water between 1:20 and 20:1 and a temperature above
40° C.

5. The method according to claim 1,
characterized in that
the mechanical partial extraction of oil from the shelled sunflower seeds or rapeseeds is carried out by pressing at an average temperature of the shelled sunflower seeds or rapeseeds of less than 80° C. over the duration of the pressing operation, the at least one extraction step is carried out at a temperature below 80° C., and the desolventing takes place at a temperature below 100° C.,
and that after the desolventing a treatment of proteins of the sunflower seeds or rapeseeds with an alcohol-water mixture is carried out and then the proteins are brought to a temperature >100° C.

6. The method according to claim 1,
characterized in that
the desolventing is carried out by distillation separation of the solvent, particularly with the introduction of heat by means of one or more superheated organic solvents and/or by the use of water vapour.

7. The method according to claim 1,
characterized in that
a temperature of >90° C., preferably >100° C., and below
150° C. is chosen for the desolventing.

8. The method according to claim 1,
characterized in that
the mechanical partial extraction of oil is carried out in such manner that a temperature of the shelled sunflower seeds or rapeseeds rises above a value of 75° C. during the mechanical partial extraction of oil.

9. The method according to any one of claim 8,
characterized in that
the temperature is chosen at such a value that a press cake obtained by the mechanical partial extraction of oil has a fracture pressure greater than 10 N/mm².

10. The method according to claim 1,
characterized in that
a mechanical treatment of a press cake obtained by the mechanical partial extraction of oil is performed between the mechanical partial extraction of oil and the at least one extraction step.

11. A protein ingredient for animal feeds which is obtained from proteins of rapeseeds and has
a solvent content, particularly a hexane content, between 0.0001 and 2 wt % and/or an alcohol content between 0.0001 and 2 wt %,
a protein content of >45 wt % and <80 wt %,
a fat content of <3.5 wt %,
a protein solubility of <40%,
a shell content less than 5 wt %, advantageously <2 wt %, particularly advantageously <0.5 wt %,
a denaturing of >40% of the proteins, and
a digestibility of >60% of the proteins.

12. A protein ingredient for animal feeds which is obtained from proteins of sunflower seeds and has
a solvent content, particularly hexane content, between 0.0001 and 2 wt % and/or an alcohol content between 0.0001 and 2 wt %,
a protein content of >45 wt % and <80 wt %,
a fat content of <3.5 wt %,
a protein solubility of <30%,
a shell content less than 5 wt %, advantageously <2 wt %, particularly advantageously <0.5 wt %,
a denaturing of >40% of the proteins, and
a digestibility of >70% of the proteins.

13. A protein ingredient for animal feeds which contains a mixture of soya proteins with a protein ingredient according to claim 12 or a protein ingredient produced from sunflower seeds according to the method according to claim 1.

14. The protein ingredient according to claim 13,
characterized in that
a protein mixture ratio between the soya proteins and the proteins of the protein ingredient lies between 1:10 and 10:1, advantageously between 30:70 and 70:30, particularly advantageously at 50:50 relative to the protein content.

15. A substitute for animal proteins in animal feeds, said substitute comprising a protein ingredient produced with the method according to claim 1.

16. Animal feed for carnivorous animals comprising protein ingredient produced with the method according to claim 1, alone or in conjunction with other plant proteins as a primary source of protein.
